(19) United States
(12) Patent Application Publication
(10) Pub. No.: US 2025/0207713 A1
(43) Pub. Date: Jun. 26, 2025

(54) FLUID SWIVELS AND PROCESSES FOR PIGGING THERETHROUGH

(71) Applicant: SOFEC, INC., HOUSTON, TX (US)

(72) Inventor: Miles A. Hobdy, Richmond, TX (US)

(73) Assignee: SOFEC, INC., Houston, TX (US)

(21) Appl. No.: 18/983,410

(22) Filed: Dec. 17, 2024

Related U.S. Application Data
(60) Provisional application No. 63/612,588, filed on Dec. 20, 2023.

(51) Int. Cl. F16L 55/46; F16L 39/06

(52) U.S. Cl. CPC F16L 55/46; F16L 39/06

(57) ABSTRACT

Apparatus that include fluid swivels and processes for pigging through the fluid swivels. In some embodiments, the apparatus can include a fluid swivel. The fluid swivel can include a fixed part that defines a first longitudinal fluid path therethrough and a first radial fluid path in fluid communication with the first longitudinal fluid path. The fluid swivel can also include a rotating part that defines a first radial fluid path therethrough. The first longitudinal fluid path can be configured to pass a pig therethrough. The first fixed part and the first rotating part can define a first toroidal fluid path therebetween that can be in fluid communication with the first radial fluid path defined by the fixed part and the first radial fluid path defined by the rotating part.

### CROSS-REFERENCE TO RELATED APPLICATION

This application claims priority to U.S. Provisional Patent Application No. 63/612,588, filed on Dec. 20, 2023, which is incorporated by reference herein.

### FIELD

Embodiments described herein generally relate to fluid swivels and processes for pigging therethrough. More particularly, such embodiments relate to apparatus that include fluid swivels and processes for pigging through the fluid swivels.

### BACKGROUND

In the offshore oil and gas industry, it is common to configure a floating vessel to rotate about a rotationally fixed or geostationary structure. This can be accomplished, for example with a turret mooring system. The turret mooring system can include a rotating part connected to the floating vessel and a fixed part connected to the seabed that are connected to one another via a bearing. Such turret mooring systems typically include a fluid conveyance system to provide fluid communication between the vessel and subsea wells or fluid conduits located on the seabed. Such fluid conveyance system spans or crosses from the fixed part of the turret to the rotating part of the turret and maintains fluid communication between the rotating part of the turret and the fixed part of the turret as the vessel and the rotating part of the turret rotate about the fixed part of the turret. In instances where there is more than one fluid conduit crossing from the fixed part of the turret to the rotating part of the turret, toroidal swivels are employed.

It is often necessary or desirable to launch a pipeline inspection gauge (pig) from the vessel or turret to a subsea fluid conduit or to receive a pig on the vessel or turret that originates from a subsea fluid conduit. This has been accomplished with pigging facilities such as pig launchers and/or pig receivers that are positioned on the fixed part of the turret. In instances where toroidal swivels are employed, the pig launcher and/or pig receiver is disposed or located below the fluid swivel because it is not possible to pass certain types of pigs through a toroidal swivel. Such pig launcher and/or receiver and associated facilities can require significant space, structures, and equipment, which causes the fluid swivel to be located at a significant elevation above the bearing system of the turret. This configuration is not ideal as it requires significant structural and mechanical elements to maintain the necessary axial alignment between the fluid swivel and the bearing of the turret.

There is a need, therefore, for apparatus and processes for launching a pig from a vessel to a subsea location or for launching a pig from a subsea location to the vessel, where the pig passes through a fluid swivel disposed on the vessel.

### SUMMARY

Apparatus that include fluid swivels and processes for pigging through the fluid swivels are provided. In some embodiments, the apparatus can include a fluid swivel that can include a fixed part and a rotating part. The fixed part can define a first longitudinal fluid path therethrough and a first radial fluid path in fluid communication with the first longitudinal fluid path. The rotating part can define a first radial fluid path therethrough. The first longitudinal fluid path can be configured to pass a pig therethrough. The first fixed part and the first rotating part can define a first toroidal fluid path therebetween that can be in fluid communication with the first radial fluid path defined by the fixed part and the first radial fluid path defined by the rotating part.

In other embodiments, the apparatus can include a fluid swivel that can include a fixed part, a first rotating part, and a second rotating part. The fixed part can define a first longitudinal fluid path therethrough, a second longitudinal fluid path partially therethrough, a first radial fluid path in fluid communication with the first longitudinal fluid path, and a second radial fluid path in fluid communication with the second longitudinal fluid path. The first rotating part can define a radial fluid path therethrough. The second rotating part can define a radial fluid path therethrough. The first longitudinal fluid path can be configured to pass a pig therethrough. The fixed part and the first rotating part can define a toroidal fluid path therebetween that can be in fluid communication with the first radial fluid path defined by the fixed part and the radial fluid path defined by the first rotating part. The fixed part and the second rotating part can define a toroidal fluid path therebetween that can be in fluid communication with the second radial fluid path defined by the fixed part and the radial fluid path defined by the second rotating part.

In still other embodiments, the apparatus can include a fluid swivel that can include a first fixed part, a second fixed part, a first rotating part, and a second rotating part. The first fixed part can define a first longitudinal fluid path and a second longitudinal fluid path therethrough and a radial fluid path in fluid communication with the first longitudinal fluid path defined by the first fixed part. The second fixed part can define a first longitudinal fluid path therethrough, a second longitudinal fluid path partially therethrough, and a radial fluid path in fluid communication with the second longitudinal fluid path defined by the second fixed part. The first rotating part can define a radial fluid path therethrough. The second rotating part can define a radial fluid path therethrough. The first fixed part and the second fixed part can be fixedly connected to one another. The first longitudinal fluid path defined by first fixed part and the first longitudinal fluid path defined by the second fixed part can be configured to pass a pig therethrough. The first fixed part and the first rotating part can define a toroidal fluid path therebetween that can be in fluid communication with the radial fluid path defined by the first fixed part and the radial fluid path defined by the first rotating part. The second fixed part and the second rotating part can define a toroidal fluid path therebetween that can be in fluid communication with the radial fluid path defined by the second fixed part and the radial fluid path defined by the second rotating part.

### BRIEF DESCRIPTION OF THE DRAWINGS

The various aspects and advantages of the preferred embodiment of the present invention will become apparent to those skilled in the art upon an understanding of the following detailed description of the invention, read in light of the accompanying drawings which are made a part of this specification.

FIG. 1 depicts a cross-section elevational view of an illustrative fluid swivel that includes a fixed part and a rotating part that define a toroidal fluid path therebetween in fluid communication with a longitudinal fluid path defined by the fixed part via a radial fluid path defined by the fixed part, the radial fluid path including a structure that partially obstructs the fluid communication between the toroidal fluid path and the longitudinal fluid path, according to one or more embodiments described.

FIG. 2 depicts a plan view of the fluid swivel shown in FIG. 1.

FIG. 3 depicts a cross-section elevational view of another illustrative fluid swivel that includes a fixed part and a rotating part that define a first toroidal fluid path and a second toroidal fluid path therebetween, the first toroidal fluid path being in fluid communication with a first longitudinal fluid path defined by the fixed part via a first radial fluid path defined by the fixed part, the first longitudinal fluid path including a structure secured to an inner wall thereof that partially obstructs the fluid communication between the first toroidal fluid path and the first longitudinal fluid path, according to one or more embodiments described.

FIG. 4 depicts a plan view of the fluid swivel shown in FIG. 3.

FIG. 5 depicts a cross-section elevational view of another illustrative fluid swivel that includes a fixed part, a first rotating part, and a second rotating part, the fixed part and the first rotating part defining a first toroidal fluid path therebetween, the first toroidal fluid path being in fluid communication with a first longitudinal fluid path defined by the fixed part via a first radial fluid path defined by the fixed part, the first radial fluid path and the first longitudinal fluid including a structure that partially obstructs the fluid communication between the first toroidal fluid path and the first longitudinal fluid path, according to one or more embodiments described.

FIG. 6 depicts a cross-section elevational view of another illustrative fluid swivel that includes a first fixed part and a first rotating part that define a first toroidal fluid path therebetween, the first toroidal fluid path in fluid communication with a first longitudinal fluid path defined by the first fixed part via a first radial fluid path defined by the first fixed part, the first radial fluid path including a structure that partially obstructs the fluid communication between the first toroidal fluid path and the first longitudinal fluid path, according to one or more embodiments described.

FIG. 7 depicts a cross-section elevational view of the fluid swivel shown in FIG. 3 configured to launch a pig from a pig launcher through the first longitudinal fluid path defined by the fixed part of the fluid swivel, according to one or more embodiments described.

FIG. 8 depicts a cross-section elevational view of the fluid swivel shown in FIG. 3 configured to receive a pig from a pig launcher/receiver through the first longitudinal fluid path defined by the fixed part of the fluid swivel and into the pig launcher/receiver, according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references to the “invention”, in some cases, refer to certain specific or preferred embodiments only. In other cases, references to the “invention” refer to subject matter recited in one or more, but not necessarily all, of the claims. It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the figures provided herein. This repetition is for the purpose of simplicity and clarity and does not in itself dictate a relationship between the various exemplary embodiments and/or configurations discussed in the Figures. Moreover, the formation of a first feature over or on a second feature in the description that follows includes embodiments in which the first and second features are formed in direct contact and also includes embodiments in which additional features are formed interposing the first and second features, such that the first and second features are not in direct contact. The exemplary embodiments presented below may be combined in any combination of ways, i.e., any element from one exemplary embodiment may be used in any other exemplary embodiment, without departing from the scope of the disclosure. The figures are not necessarily drawn to scale and certain features and certain views of the figures can be shown exaggerated in scale or in schematic for clarity and/or conciseness.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Also, the naming convention used herein is not intended to distinguish between components that differ in name but not function. Furthermore, in the following discussion and in the claims, the terms “including” and “comprising” are used in an open-ended fashion, and thus should be interpreted to mean “including, but not limited to.”

All numerical values in this disclosure are exact or approximate values (“about”) unless otherwise specifically stated. Accordingly, various embodiments of the disclosure may deviate from the numbers, values, and ranges disclosed herein without departing from the intended scope.

Further, the term “or” is intended to encompass both exclusive and inclusive cases, i.e., “A or B” is intended to be synonymous with “at least one of A and B,” unless otherwise expressly specified herein. The indefinite articles “a” and “an” refer to both singular forms (i.e., “one”) and plural referents (i.e., one or more) unless the context clearly dictates otherwise. The terms “up” and “down”; “upward” and “downward”; “upper” and “lower”; “upwardly” and “downwardly”; “above” and “below”; and other like terms used herein refer to relative positions to one another and are not intended to denote a particular spatial orientation since the apparatus and methods of using the same may be equally effective at various angles or orientations.

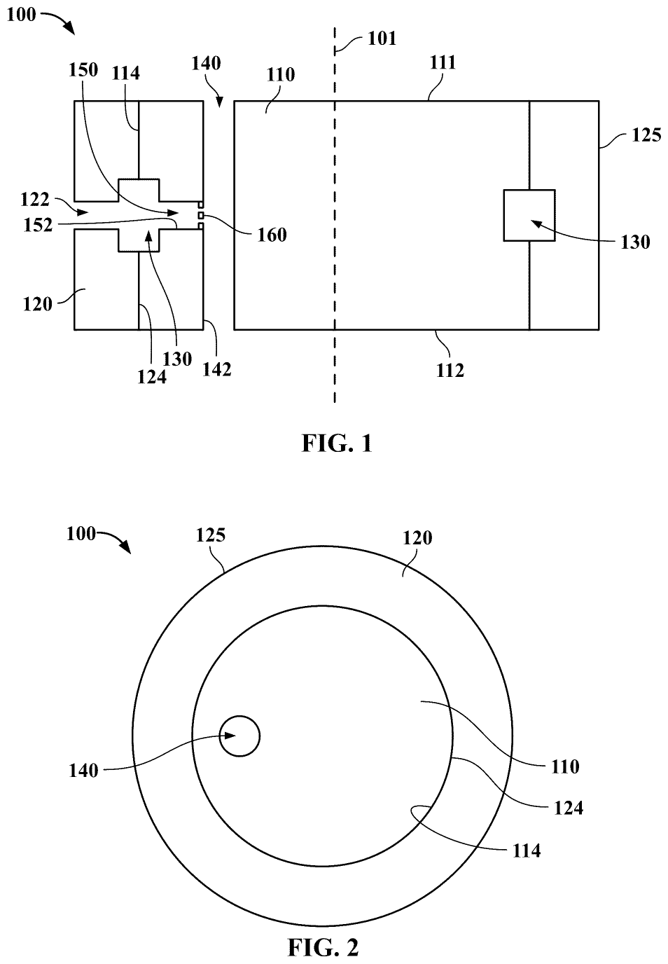

FIG. 1 depicts a cross-section elevational view of an illustrative fluid swivel 100 that includes a fixed part 110 and a rotating part 120 that define a toroidal fluid path 130 therebetween in fluid communication with a longitudinal fluid path 140 defined by the fixed part 110 via a radial fluid path 150 defined by the fixed part 110, the radial fluid path 150 that can include a structure 160 that partially obstructs the fluid communication between the toroidal fluid path 130 and the longitudinal fluid path 140, according to one or more embodiments. FIG. 2 depicts a plan view of the fluid swivel 100 shown in FIG. 1.

The fixed part 110 can be configured to be fixedly disposed on or mounted on any fixed object or structure, for example a fixed part of a turret disposed on a vessel or buoy, not shown. In some embodiments, the fixed part 110 can be configured as a substantially solid cylinder that can include one or more fluid paths defined at least partially therethrough and/or otherwise therein. In other embodiments the fixed part 110 can have a hollow cylindrical core that can include pipes, hoses, other conduits configured to provide one or more fluid paths disposed therein, cables, or any other elongated member(s) (not shown).

In some embodiments, the rotating part 120 can be in the form of an annular ring that can be disposed about the fixed part 110 and can rotate with respect to the fixed part 110. More particularly, an inner surface 124 of the rotating part 120 can abut an exterior surface 114 of the fixed part 110. The rotating part 120 of the fluid swivel 100 can define one or more radial fluid paths 122 therethrough. In some embodiments, the rotating part 120 can define 1, 2, 3, 4, 5, 6 7, 8, 9, 10, or more radial fluid paths 122 therethrough. It should be understood that one or more sealing elements can be disposed between the inner surface 124 of the rotating part 120 and the exterior surface 114 of the fixed part 110. It should also be understood that an exterior surface 125 of the rotating part 120 can be circular in shape, as shown, or can have any other desired shape profile.

In some embodiments, the fluid swivel 100 can have a longitudinal axis 101 that can pass through a center point of the cross-section of the fixed part 110. In some embodiments, the longitudinal fluid path 140 can be oriented such that it is parallel or substantially parallel with the longitudinal axis 101 of the fluid swivel 100. In some embodiments, the longitudinal fluid path 140 can be positioned at a distance away from the longitudinal fluid path 140, as shown. In other embodiments, the longitudinal fluid path 140 can be positioned to be coincident or substantially coincident with the longitudinal axis 101, not shown.

In some embodiments, the longitudinal fluid path 140 can extend completely through the fixed part 110, i.e., from a first or top side 111 to a second or bottom side 112 of the fixed part 110. In some embodiments, the longitudinal fluid path 140 can be configured to pass or convey a pig from the first side 111 to the second side 112 of the fixed part 110 and/or from the second side 112 to the first side 111 of the fixed part 110.

The fixed part 110 can also define or otherwise include the radial fluid path 150. In some embodiments, the radial fluid path 150 can be positioned normal or substantially normal to the exterior surface 114 of the fixed part 110. The longitudinal fluid path 140 and the radial fluid path 150 can be in fluid communication with one another.

The fixed part 110 and the rotating part 120 can define the toroidal fluid path 130 therebetween. As such, the radial fluid path 122 defined by the rotating part 120 and the radial fluid path 150 defined by the fixed part 110 can be in fluid communication with one another via the toroidal fluid path 130. Said another way, the toroidal fluid path 130 can be in fluid communication with the radial fluid path 150 defined by the fixed part 110 and the radial fluid path 122 defined by the rotating part 120. In some embodiments, a fluid can be introduced into the radial fluid path 122 defined by the rotating part 120, flow into the toroidal fluid path 130 defined between the fixed part 110 and the rotating part 120, flow into the radial fluid path 150 defined by the fixed part 110, and can flow into the longitudinal fluid path 140. In other embodiments, a fluid can be introduced into the longitudinal fluid path 140, flow through the longitudinal fluid path 140 and/or into the radial fluid path 150 defined by the fixed part 110, into the toroidal fluid path 130, and into the radial fluid path 122 defined by the rotating part 120. The fluid can be any liquid, gas, slurry, or any mixture thereof. In some embodiments, the fluid can be or can include, but is not limited to, one or more hydrocarbon gases, e.g., natural gas, carbon dioxide, crude oil, water, or any mixture thereof. In some embodiments, the slurry can be crude oil that can contain sand, fragments or pieces rock, asphaltenes, and/or other solid components.

In some embodiments, the radial fluid path 150 defined by or otherwise included within the fixed part 110 can include the structure 160 disposed therein, as shown in FIG. 1. The structure 160 can be configured to prevent a pig from passing from the longitudinal fluid path 140 into the radial fluid path 150. In some embodiments, the structure 160 can be located within the radial fluid path 150 toward an intersection between the longitudinal fluid path 140 and the radial fluid path 150.

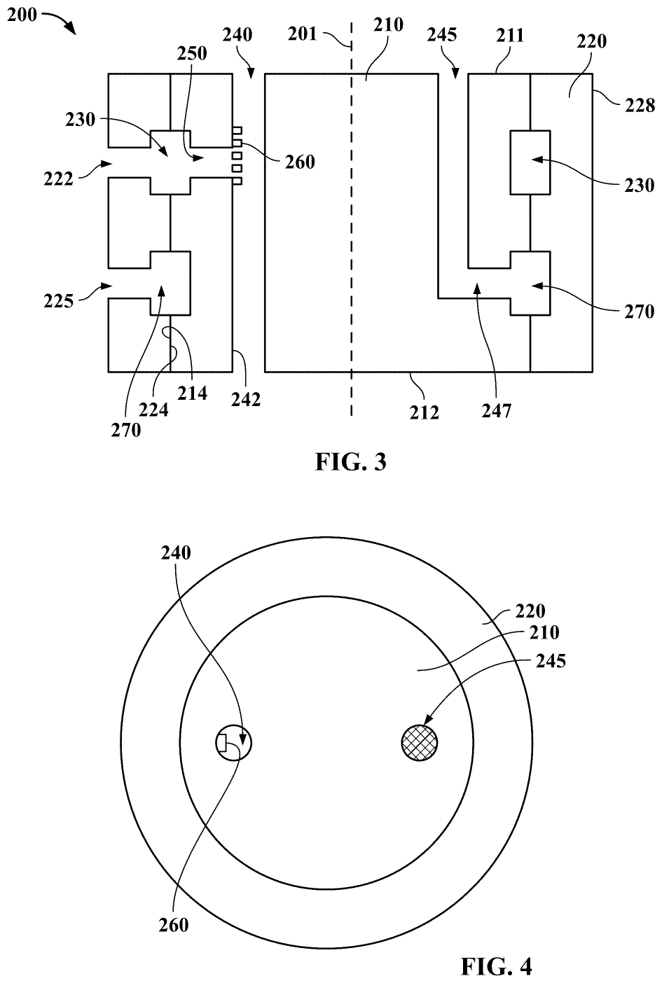

In other embodiments, the structure 160 can be located within the longitudinal fluid path 140. For example, the structure 160 can be secured to an inner wall or surface 142 of the longitudinal fluid path 140 such that the structure 160 at least partially extends or completely extends across the radial fluid path 150 to prevent a pig from passing from the longitudinal fluid path 140 into the radial fluid path 150 while still allowing fluid communication between the longitudinal fluid path 140 and the radial fluid path 150. An embodiment showing another structure 260 located within a longitudinal fluid path 240 is shown in FIG. 3.

In still other embodiments, the structure 160 can be partially located within the radial fluid path 150 and partially within the longitudinal fluid path 140. When the structure 160 is disposed within the longitudinal fluid path 140 or partially within the longitudinal fluid path 140 and partially within the radial fluid path 150, the structure 160 can be configured to allow a pig to pass through the longitudinal fluid path 140.

In some embodiments, the structure 160 can be or can include, but is not limited to, one or more bars, one or more plates, a gate, a grate, a screen, any other structural member, or any combination thereof. The structure 160 can have any configuration that allows fluid to pass from the longitudinal fluid path 140 into the radial fluid path 150 or from the radial fluid path 150 into the longitudinal fluid path 140 while preventing a pig from passing from the longitudinal fluid path 140 into the radial fluid path 150. In some embodiments, the structure 160 can be or can include one or more protrusions extending from an inner wall or surface 152 of the radial fluid path 150 and not completely across or between opposing sides of the radial fluid path 150. The structure 160 can be secured, fixed, attached, or otherwise connected to the inner wall or surface 152 of the radial fluid path 150 and/or the inner surface 142 of the longitudinal fluid path 140 via any suitable manner. In some embodiments, the structure 160 can be integral with the inner surface 152 and/or the inner surface 142, e.g., via casting, molding, milling, or the like. In other embodiments, the structure 160 can be connected to the inner surface 152 and/or the inner surface 142 via welding, one or more mechanical fasteners, e.g., bolts, bolts and nuts, screws, rivets, or the like, brazing, and the like. The structure 160 can be formed from one or more metals, e.g., aluminum, one or more metal alloys, e.g., stainless steel, one or more polymers, or any other suitable material.

FIG. 3 depicts a cross-section elevational view of another illustrative fluid swivel 200 that includes a fixed part 210 and a rotating part 220 that define a first toroidal fluid path 230 and a second toroidal fluid path 270 therebetween, the first toroidal fluid path 230 being in fluid communication with a first longitudinal fluid path 240 defined by the fixed part 210 via a first radial fluid path 250 defined by the fixed part 210, the first longitudinal fluid path 240 including a structure 260 secured to an inner wall or surface 242 thereof that partially obstructs the fluid communication between the first toroidal fluid path 250 and the first longitudinal fluid path 240, according to one or more embodiments. FIG. 4 depicts a plan view of the fluid swivel 200 shown in FIG. 3.

The fixed part 210 can be configured to be fixedly disposed on or mounted on any fixed object or structure, for example a fixed part of a turret disposed on a vessel or buoy, not shown. In some embodiments, the fixed part 210 can be configured as a substantially solid cylinder that can include one or more fluid paths (four are shown 240, 250, 245, 247) defined at least partially therethrough and/or otherwise therein. As shown, the fluid paths 240 and 245 can be longitudinal fluid paths that can extend completely through the fixed part 210 and partially through the fixed part 210, respectively. As also shown, the fluid paths 250, 247 can be a first and a second radial fluid path. The first radial fluid path 250 can be in fluid communication with the first longitudinal fluid path 240 and the first toroidal fluid path 230. The second radial fluid path 247 can be in fluid communication with the second longitudinal fluid path 245 and the second toroidal fluid path 270. In other embodiments the fixed part 210 can have a hollow cylindrical core that can include pipes, hoses, other conduits configured to provide one or more fluid paths disposed therein, cables, or any other elongated member(s) (not shown).

In some embodiments, the rotating part 220 can be in the form of an annular ring that can be disposed about the fixed part 210 and can rotate with respect to the fixed part 210. More particularly, an inner surface 224 of the rotating part 220 can abut an exterior surface 214 of the fixed part 210. The rotating part 220 of the fluid swivel 200 can define one or more radial fluid paths (two are shown, 222, 225) therethrough. The first radial fluid path 222 defined by the rotating part 220 can be in fluid communication with the first toroidal fluid path 230. In some embodiments, the rotating part 220 of the fluid swivel can define 1, 2, 3, 4, 5, 6, 7, 8, 9, 10, or more first radial fluid paths 222 that can be in fluid communication with the first toroidal fluid path 230. The second radial fluid path 225 can be in fluid communication with the second toroidal fluid path 270. In some embodiments, the rotating part 220 of the fluid swivel can define 1, 2, 3, 4, 5, 6, 7, 8, 9, 10, or more second radial fluid paths 225 that can be in fluid communication with the second toroidal fluid path 270. It should be understood that one or more scaling elements can be disposed between the inner surface 224 of the rotating part 220 and the exterior surface 214 of the fixed part 210 on either or both sides of each toroidal fluid path 230, 270. It should also be understood that an exterior surface 228 of the rotating part 220 can be circular in shape, as shown, or can have any other desired shape profile.

In some embodiments, the fluid swivel 200 can have a longitudinal axis 201 that can pass through a center point of the cross-section of the fixed part 210. In some embodiments, the first longitudinal fluid path 240 and the second longitudinal fluid path 245 can be oriented such that they are parallel or substantially parallel with the longitudinal axis 201 of the fluid swivel 200. In some embodiments, the first longitudinal fluid path 240 can be positioned at a distance away from the longitudinal axis 201, as shown. In other embodiments, the first longitudinal fluid path 240 can be positioned to be coincident or substantially coincident with the longitudinal axis 201, not shown. In some embodiments, the second longitudinal fluid path 245 can be positioned at a distance away from the longitudinal axis 201, as shown. In other embodiments, the second longitudinal fluid path 246 can be positioned to be coincident or substantially coincident with the longitudinal axis 201, not shown.

In some embodiments, the first longitudinal fluid path 240 can extend completely through the fixed part 210, i.e., from a first or top side 211 to a second or bottom side 212 of the fixed part 210. In some embodiments, the first longitudinal fluid path 240 can be configured to pass or convey a pig from the first side 211 to the second side 212 of the fixed part 210 and/or from the second side 212 to the first side 211 of the fixed part 110. In some embodiments, the second longitudinal fluid path 245 can extend from the first side 211 and partially toward the second side 212 of the fixed part 210. Said another way, the first longitudinal fluid path 240 can extend completely through the fixed part 210 and the second longitudinal fluid path 245 can partially through the fixed part 210.

The fixed part 210 can also define or otherwise include the first radial fluid path 250 and the second radial fluid path 247. In some embodiments, the first radial fluid path 250 can be positioned normal or substantially normal to the exterior surface 214 of the fixed part 210. The first longitudinal fluid path 240 and the first radial fluid path 250 can be in fluid communication with one another. In some embodiments, the second radial fluid path 247 can be positioned normal or substantially normal to the exterior surface 214 of the fixed part 210. The second longitudinal fluid path 245 and the second radial fluid path 247 can be in fluid communication with one another.

The fixed part 210 and the rotating part 220 can define the first toroidal fluid path 230 and the second toroidal fluid path 270 therebetween. As such, the first radial fluid path 222 defined by the rotating part 220 and the first radial fluid path 250 defined by the fixed part 210 can be in fluid communication with one another via the first toroidal fluid path 230. Said another way, the first toroidal fluid path 230 can be in fluid communication with the first radial fluid path 250 defined by the fixed part 210 and the first radial fluid path 222 defined by the rotating part 220. Likewise, the second radial fluid path 225 defined by the rotating part 220 and the second radial fluid path 247 defined by the fixed part 210 can be in fluid communication with one another via the second toroidal fluid path 270. Said another way, the toroidal fluid path 230 can be in fluid communication with the radial fluid path 250 defined by the fixed part 210 and the radial fluid path defined by the rotating part 220.

In some embodiments, a fluid can be introduced into the first radial fluid path 222 defined by the rotating part 220, flow into the first toroidal fluid path 230 defined between the fixed part 210 and the rotating part 220, flow into the first radial fluid path 250 defined by the fixed part 210, and can flow into the first longitudinal fluid path 240. In other embodiments, a fluid can be introduced into the first longitudinal fluid path 240, flow through the first longitudinal fluid path 240 and/or into the first radial fluid path 250 defined by the fixed part 210, into the first toroidal fluid path 230, and into the first radial fluid path 222 defined by the rotating part 220.

In some embodiments, a fluid can be introduced into the second radial fluid path 225 defined by the rotating part 220, flow into the second toroidal fluid path 270 defined between the fixed part 210 and the rotating part 220, flow into the second radial fluid path 247 defined by the fixed part 210, and can flow into the second longitudinal fluid path 245. In other embodiments, a fluid can be introduced into the second longitudinal fluid path 245, flow through the second longitudinal fluid path 245 and into the second radial fluid path 247 defined by the fixed part 210, into the second toroidal fluid path 270, and into the second radial fluid path 225 defined by the rotating part 220.

In some embodiments, the structure 260 can be located within the first longitudinal fluid path 240. For example, the structure 260 can be secured to an inner wall or surface 242 of the first longitudinal fluid path 240 such that the structure at least partially extends or completely extends (as shown) across the first radial fluid path 250 to prevent a pig from passing from the first longitudinal fluid path 240 into the first radial fluid path 250 while still allowing fluid communication between the first longitudinal fluid path 240 and the first radial fluid path 250.

In some embodiments, the structure 260 can be or can include, but is not limited to, one or more bars, one or more plates, a gate, a grate, a screen, or any other member. The structure 260 can have any configuration that allows fluid to pass from the first longitudinal fluid path 240 into the first radial fluid path 250 or from the first radial fluid path 250 into the first longitudinal fluid path 240 while preventing a pig from passing from the first longitudinal fluid path 240 into the first radial fluid path 250. In some embodiments, the structure 260 can be or can include one or more protrusions extending from an inner wall or surface of the first radial fluid path 250 and not completely across or between opposing sides of the first radial fluid path 250. The structure 260 can be secured, fixed, attached, or otherwise connected to the inner wall or surface 242 of the first longitudinal fluid path 240 via any suitable manner. In some embodiments, the structure 260 can be integral with the inner wall or surface 242, e.g., via casting, molding, milling, or the like. In other embodiments, the structure 260 can be connected to the inner wall or surface 242 via welding, one or more mechanical fasteners, e.g., bolts, bolts and nuts, screws, rivets, or the like, brazing, and the like. The structure 260 can be formed from one or more metals, e.g., aluminum, one or more metal alloys, e.g., stainless steel, one or more polymers, or any other suitable material.

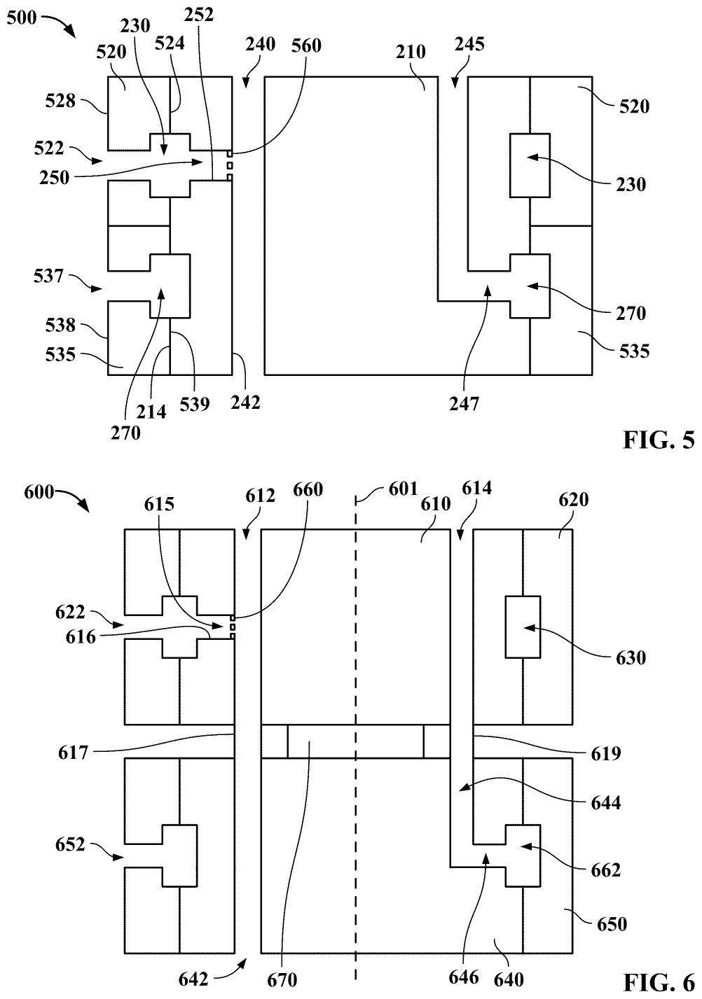

FIG. 5 depicts a cross-section elevational view of another illustrative fluid swivel 500 that includes a fixed part 210, a first rotating part 520, and a second rotating part 535, the fixed part 210 and the first rotating part 520 defining a first toroidal fluid path 230 therebetween, the first toroidal fluid path 230 being in fluid communication with a first longitudinal fluid path 240 defined by the fixed part 210 via a first radial fluid path 250 defined by the fixed part 210, the first radial fluid path 250 and the first longitudinal fluid path 240 including a structure 560 that partially obstructs the fluid communication between the first toroidal fluid path 230 and the first longitudinal fluid path 240, according to one or more embodiments.

The fluid swivel 500 can have substantially the same configuration as the fluid swivel 200 described above with reference to FIGS. 3 and 4. In fact, the fixed part 210 can be the same as the fixed part 210 shown in FIGS. 3 and 4 and described above with reference thereto. The first main difference between the fluid swivel 200 and the fluid swivel 500, is that the fluid swivel 500 can include the first rotating part 520 and the second rotating part 535 that define the toroidal fluid paths 230, 270, respectively, instead of the rotating part 220 that defines both toroidal fluid paths 230, 270. The second main difference between the fluid swivel 200 and the fluid swivel 500 is that the structure 560 can be partially disposed within the first radial fluid path 250 and the first longitudinal fluid path 240.

As shown in FIG. 5, the first rotating part 520 and the fixed part 210 can define the first toroidal fluid path 230 and the second rotating part 535 and the fixed part 210 can define the second toroidal fluid path 270. As such, the first rotating part 520 can define one or more radial fluid paths 522 therethrough and the second rotating part 535 can define one or more radial fluid path 537 therethrough. In some embodiments, the first rotating part 520 of the fluid swivel 500 can define 1, 2, 3, 4, 5, 6, 7, 8, 9, 10, or more radial fluid paths 522 that can be in fluid communication with the first toroidal fluid path 230. In some embodiments, the second rotating part 535 of the fluid swivel 500 can define 1, 2, 3, 4, 5, 6, 7, 8, 9, 10 or more radial fluid paths 357 that can be in fluid communication with the second toroidal fluid path 270.

The fixed part 210 can be configured to be fixedly disposed on or mounted on any fixed object or structure, for example a fixed part of a turret disposed on a vessel or buoy, not shown. In some embodiments, the fixed part 210 can be configured as a substantially solid cylinder that can include the fluid paths (four are shown 240, 250, 245, 247) defined at least partially therethrough and/or otherwise therein. In other embodiments the fixed part 210 can have a hollow cylindrical core that can include pipes, hoses, other conduits configured to provide one or more fluid paths disposed therein, cables, or any other elongated member(s) (not shown).

In some embodiments, the first rotating part 520 and the second rotating part 535 can be in the form of an annular ring that can be disposed about the fixed part 210 and can rotate with respect to the fixed part 210. More particularly, an inner surface 524 of the first rotating part 520 can abut an exterior surface 214 of the fixed part 210 and an inner surface 539 of the second rotating part 535 can abut the exterior surface 214 of the fixed part 210. As noted above, the first rotating part 520 can define one or more radial fluid paths 522 and the second rotating part 535 can define one or more radial fluid paths 537 therethrough. The radial fluid path 522 defined by the first rotating part 520 can be in fluid communication with the first toroidal fluid path 230 and the radial fluid path 537 defined by the second rotating part 535 can be in fluid communication with the second toroidal fluid path 270. It should be understood that one or more sealing elements can be disposed between the inner surface 524 of the first rotating part 520 and the exterior surface 214 of the fixed part 210 and one or more sealing elements can be disposed between the inner surface 539 of the second rotating part 535 and the exterior surface 214 of the fixed part 210. It should also be understood that an exterior surface 528 of the first rotating part 520 and the exterior surface 538 of the second rotating part 535 can be circular in shape, as shown, or can independently have any other desired shape or profile.

In some embodiments, the first rotating part 520 and the second rotating part 535 can be fixedly connected to one another such that the first rotating part 520 and the second rotating part 535 can rotate about the fixed part 210 simultaneously and to the same degree with respect to one another. In other embodiments, the first rotating part 520 and the second rotating part 535 can be independent from one another such that the first rotating part 520 and the second rotating part 535 can rotate independently with respect to one another about the fixed part 210.

In some embodiments, the structure 560 can be located partially within the first radial fluid path 250 defined by the fixed part 210 and partially within the first longitudinal fluid path 240. For example, the structure 560 can be secured to an inner wall or surface 242 of the first longitudinal fluid path 240 and/or to an inner wall or surface 252 of the first radial fluid path 250 such that the structure at least partially extends or completely extends (as shown) across the first radial fluid path 250 to prevent a pig from passing from the first longitudinal fluid path 240 into the first radial fluid path 250 while still allowing fluid communication between the first longitudinal fluid path 240 and the first radial fluid path 250.

In some embodiments, the structure 560 can be or can include, but is not limited to, one or more bars, one or more plates, a gate, a grate, a screen, or any other member. The structure 560 can have any configuration that allows fluid to pass from the first longitudinal fluid path 240 into the first radial fluid path 250 or from the first radial fluid path 250 into the first longitudinal fluid path 240 while preventing a pig from passing from the first longitudinal fluid path 240 into the first radial fluid path 250. In some embodiments, the structure 560 can be or can include one or more protrusions extending from an inner wall or surface of the first radial fluid path 250 and not completely across or between opposing sides of the first radial fluid path 250. The structure 560 can be secured, fixed, attached, or otherwise connected to the inner wall or surface 242 of the first longitudinal fluid path 240 and/or the inner surface 252 of the first radial fluid path 250 via any suitable manner. In some embodiments, the structure 560 can be integral with the inner wall or surface 242 and/or the inner surface 252, e.g., via casting, molding, milling, or the like. In other embodiments, the structure 560 can be connected to the inner wall or surface 242 and/or the inner surface 252 via welding, one or more mechanical fasteners, e.g., bolts, bolts and nuts, screws, rivets, or the like, brazing, and the like. The structure 560 can be formed from one or more metals, e.g., aluminum, one or more metal alloys, e.g., stainless steel, one or more polymers, or any other suitable material.

FIG. 6 depicts a cross-section elevational view of another illustrative fluid swivel 600 that includes a first fixed part 610 and a first rotating part 620 that define a first toroidal fluid path 630 therebetween, the first toroidal fluid path 630 in fluid communication with a first longitudinal fluid path 612 defined by the first fixed part 610 via a first radial fluid path 615 defined by the first fixed part 610, the first radial fluid path 615 including a structure 660 that partially obstructs the fluid communication between the first toroidal fluid path 630 and the first longitudinal fluid path 612, according to one or more embodiments. The first fixed part 610 can also define a second longitudinal fluid path 614 therethrough.

The fluid swivel 600 can also include a second fixed part 640 and a second rotating part 650 that define a second toroidal fluid path 662 therebetween. The second fixed part 640 can define a first longitudinal fluid path 642 therethrough, a second longitudinal fluid path 644 partially therethrough, and a radial fluid path 646. The radial fluid path 646 can be in fluid communication with the second toroidal fluid path 662 and the second longitudinal fluid path 644. A conduit or any other apparatus 617 can fluidly connect the first longitudinal fluid path 612 defined by the first fixed part 610 with the first longitudinal fluid path 642 defined by the second fixed part 640. A conduit or any other apparatus 619 can fluidly connect the second longitudinal fluid path 614 defined by the first fixed part 610 with the second longitudinal fluid path 644 defined by the second fixed part 640.

In some embodiments, the first fixed part 610 and the second fixed part 640 can be fixedly connected, secured, or otherwise coupled to one another. In some embodiments, a structure 670 can fixedly couple the first fixed part 610 and the second fixed part 640 to one another. In some embodiments, the structure 670 can be a plate, a plurality of bars or rods, or any other structure capable of connecting the first fixed part 610 to the second fixed part 640 of the fluid swivel 600. In some embodiments, the structure 670 can couple the first fixed part 610 to the second fixed part 640 such that the first fixed part 610 and the second fixed part 640 can be aligned along a longitudinal axis 601 with respect to one another.

The first rotating part 620 can define at least one radial fluid path 622 therethrough that can be in fluid communication with the first toroidal fluid path 630. In some embodiments, the first rotating part 620 can define 1, 2, 3, 4, 5, 6 7, 8, 9, 10, or more radial fluid paths 622 therethrough that can be in fluid communication with the first toroidal fluid path 630. The second rotating part 650 can defined at least one radial fluid path 652 therethrough that can be in fluid communication with the second toroidal fluid path 662. In some embodiments, the second rotating part 650 can define 1, 2, 3, 4, 5, 6 7, 8, 9, 10, or more radial fluid paths 652 therethrough that can be in fluid communication with the second toroidal fluid path 662.

In some embodiments, the structure 660 can be or can include, but is not limited to, one or more bars, one or more plates, a gate, a grate, a screen, or any other member. The structure 660 can have any configuration that allows fluid to pass from the first longitudinal fluid path 612 into the first radial fluid path 615 or from the first radial fluid path 615 into the first longitudinal fluid path 612 while preventing a pig from passing from the first longitudinal fluid path 612 into the first radial fluid path 615. In some embodiments, the structure 660 can be or can include one or more protrusions extending from an inner wall or surface of the first radial fluid path 615 and not completely across or between opposing sides of the first radial fluid path 615. The structure 660 can be secured, fixed, attached, or otherwise connected to an inner surface 616 of the first radial fluid path 615, as shown, via any suitable manner. In other embodiments, the structure 660 can be configured as structure 260 and/or 560 described above with reference to FIGS. 3 and 5, respectively. In some embodiments, the structure 660 can be integral with the inner surface 616, e.g., via casting, molding, milling, or the like. In other embodiments, the structure 660 can be connected to the inner surface 616 via welding, one or more mechanical fasteners, e.g., bolts, bolts and nuts, screws, rivets, or the like, brazing, and the like. The structure 660 can be formed from one or more metals, e.g., aluminum, one or more metal alloys, e.g., stainless steel, one or more polymers, or any other suitable material.

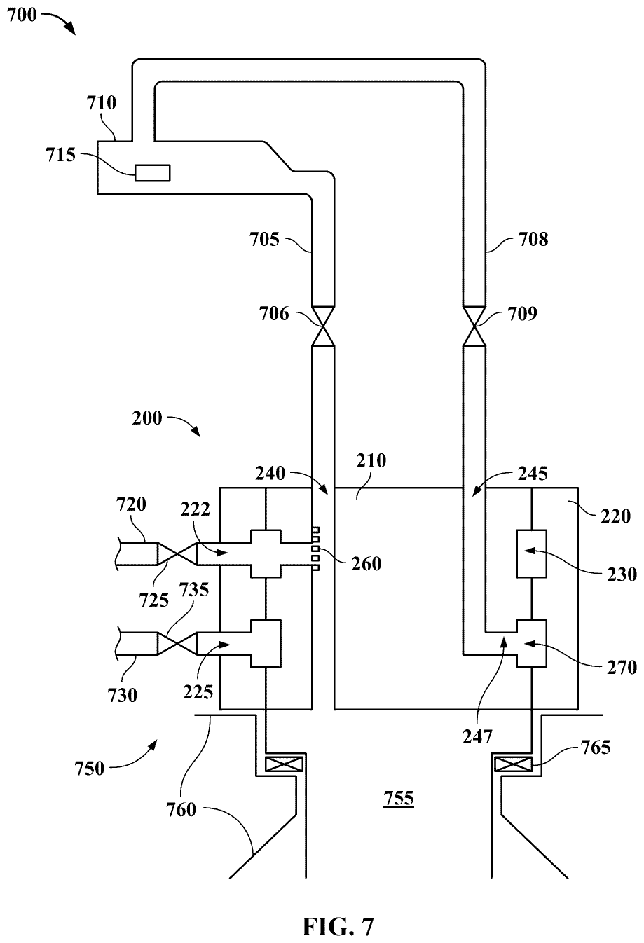

FIG. 7 depicts a cross-section elevational view of the fluid swivel 200 shown in FIG. 3 configured to launch a pig 715 from a pig launcher/receiver 710 through the first longitudinal fluid path 240 defined by the fixed part 210 of the fluid swivel 200, according to one or more embodiments. The first radial fluid path 222 can be configured to be in fluid communication with a conduit 720. The conduit 720 can include a valve or first valve 725 that can be in fluid communication with the first radial fluid path 222 defined by the rotating part 220. The first valve 725 can be configured to fluidly connect the first radial fluid path 222 and fluidly isolate the first radial fluid path 222 to/from a fluid receiving or a fluid providing source via actuation of the valve 725. The second radial fluid path 225 can be configured to be in fluid communication with a conduit 730. The conduit 730 can include a valve or second valve 735 that can be in fluid communication with the second radial fluid path 225 defined by the rotating part 220. The second valve 735 can be configured to fluidly connect the second radial fluid path 225 and fluidly isolate the second radial fluid path 225 to/from a fluid receiving or a fluid providing source via actuation of the valve 735.

The first longitudinal fluid path 240 defined by the fixed part 210 of the fluid swivel 200 can be configured to be in fluid communication via a conduit 705 with a pig launcher/receiver 710. The second longitudinal fluid path 245 defined by the fixed part 210 of the fluid swivel 200 can also be configured to be in fluid communication with the pig launcher/receiver 710 via a conduit 708. The conduit 705 can include a valve or third valve 706 that can be configured to fluidly connect the first longitudinal fluid path 240 and fluidly isolate the first longitudinal fluid path 240 with the pig launcher/receiver 710 via actuation of the third valve 706. The conduit 708 can include a valve or fourth valve 709 that can be configured to fluidly connect the second longitudinal fluid path 245 and fluidly isolate the second longitudinal fluid path 245 with the pig launcher/receiver 710. In some embodiments, the valve 706 can be a ball valve, a gate valve, a globe valve, or the like. In some embodiments, the valves 709, 725, and 735 can independently be a ball valve, a gate valve, a globe valve, a butterfly valve, a plug valve, a needle valve, or the like.

In some embodiments, a process for launching the pig 715 can include loading or otherwise inserting the pig 715 into the pig launcher/receiver 710. The first valve 725 can be closed and the second, third, and fourth valves 735, 706, and 709, respectively, can be opened. Opening the second, third, and fourth valves 735, 706, 709 can allow a fluid to flow through the second valve 735, through the second radial fluid path 225 defined by the rotating part 220, through the second toroidal fluid path 270, through the second radial fluid path 247 defined by the fixed part 210, through the second longitudinal fluid path 245 defined by the fixed part 210, through conduit 708, and into the pig launcher/receiver 710. The fluid, upon entering the pig launcher/receiver 710 can act as a motive force to move the pig 715 into the conduit 705, through the conduit 705 into the first longitudinal fluid path 240, and through the first longitudinal fluid path 240 defined by the fixed part 210 of the fluid swivel 200.

As also shown in FIG. 7, the fluid swivel 200 can be disposed on a turret 750. In some embodiments, the fixed part 210 of the fluid swivel 200 can be fixedly connected to a fixed part 755 of the turret 750 and the rotating part 220 of the fluid swivel 200 can be configured to rotate with the rotating part 760 of the turret 750. The turret 750 can include a bearing 765 that can be configured to rotatively couple the fixed part 755 of the turret 750 to the rotating part 760 of the turret 750. As also shown in FIG. 7, the fluid swivel 200 can be disposed on an upper surface of the turret 750 such that the pig launcher/receiver 710 can be located above the turret 750 and above the fluid swivel 200.

In some embodiments, a system or apparatus configured to launch or receive the pig 715 can include the turret 750, the fluid swivel 100, and the pig launcher/receiver 710. The turret 750 can include the bearing 765 that can be configured to rotatively couple the fixed part 755 of the turret 750 to the rotating part 760 of the turret 750. The fluid swivel 100 can include the fixed part 110 that can define the first longitudinal fluid path 140 therethrough and the first radial fluid path 150 in fluid communication with the first longitudinal fluid path 140. The fluid swivel 100 can also include the rotating part 120 that can define the first radial fluid path 122 therethrough. The longitudinal fluid path 140 can be configured to pass the pig 715 therethrough. The fixed part 110 and the rotating part 120 can define the toroidal fluid path 130 therebetween that can be in fluid communication with the radial fluid path 150 defined by the fixed part 110 and the radial fluid path 122 defined by the rotating part 120. The fixed part 110 of the fluid swivel 100 can be fixedly connected to the fixed part 755 of the turret 750. The rotating part 120 of the fluid swivel 100 can be configured to rotate with the rotating part 760 of the turret 750. In some embodiments, the fluid swivel 100 can be disposed between the bearing 765 of the turret 750 and the pig launcher or the pig receiver 710. In some embodiments, the fluid swivel 100 can be disposed above the bearing 765 of the turret 750 and the pig launcher or the pig receiver 710 can be disposed above the fluid swivel 100. In some embodiments, the fluid swivel 100 can also include the structure 160 disposed (i) within the radial fluid path 150 defined by the fixed part 110, (ii) within the longitudinal fluid path 140, or (iii) partially within the radial fluid path 150 defined by the fixed part 110 and partially within the longitudinal fluid path 140, where the structure 160 can be configured to prevent the pig 715 from entering the radial fluid path 150 defined by the fixed part 110 when the pig 715 passes through the longitudinal fluid path 140. In some embodiments, the pig launcher or the pig receiver 710 can be disposed on the fixed part 755 of the turret 750. In some embodiments the system or apparatus can also include the valve 706 in fluid communication with first longitudinal fluid path 140 and the pig launcher or the pig receiver 710. The valve 706 can be configured to provide fluid communication between longitudinal fluid path 140 and the pig launcher or the pig receiver 710 when in an open position and to isolate first longitudinal fluid path 140 from the pig launcher or the pig receiver 710 when in a closed position.

In some embodiments, a system or apparatus configured to launch or receive the pig 715 can include the turret 750, the fluid swivel 600, and the pig launcher/receiver 710. The turret 750 can include the bearing 765 that can be configured to rotatively couple the fixed part 755 of the turret 750 to the rotating part 760 of the turret 750. The fluid swivel can include the fixed part 210 that can define the first longitudinal fluid path 240 therethrough, the second longitudinal fluid path 245 partially therethrough, the first radial fluid path 250 in fluid communication with the first longitudinal fluid path 240, and the second radial fluid path 247 in fluid communication with the second longitudinal fluid path 245. The first rotating part 520 can define the radial fluid path 522 therethrough. The second rotating part 535 can define the radial fluid path 537 therethrough. The pig launcher or a pig receiver 710 can be disposed on the fixed part of the turret 750. The fixed part of the fluid swivel 500 can be fixedly connected to the fixed part 755 of the turret 750. The first rotating part 520 and the second rotating part 535 of the fluid swivel 500 can be configured to rotate with the rotating part 760 of the turret 750. The first longitudinal fluid path 240 can be configured to pass the pig 715 therethrough. The fixed part 210 and the first rotating part 520 of the fluid swivel 500 can define the toroidal fluid path 230 therebetween that can be in fluid communication with the first radial fluid path 250 defined by the fixed part 210 and the radial fluid path 522 defined by the first rotating part 520. The fixed part 210 and the second rotating part 535 of the fluid swivel 500 can define the toroidal fluid path 270 therebetween that can be in fluid communication with the second radial fluid path 247 defined by the fixed part 210 and the radial fluid path 537 defined by the second rotating part 535. In some embodiments, the fluid swivel 500 can further include the structure 560 disposed (i) within the first radial fluid path 250 defined by the first fixed part 210, (ii) within the first longitudinal fluid path 240, or (iii) partially within the first radial fluid path 250 defined by the fixed part 210 and partially within the first longitudinal fluid path 240, where the structure 560 can be configured to prevent the pig 715 from entering the first radial fluid path 250 defined by the fixed part 210 when the pig 715 passes through the first longitudinal fluid path 240. In some embodiments, the system or apparatus can also include the first valve 725, the second valve 735, the third valve 706, and the fourth valve 709. The first valve 725 can be in fluid communication with the radial fluid path 222 defined by the first rotating part 520 of the fluid swivel 500. The second valve 735 can be in fluid communication with the radial fluid path 537 defined by the second rotating part 535 of the fluid swivel 500. The third valve 706 can be in fluid communication with the first longitudinal fluid path 240 and the pig launcher or the pig receiver 710. The third valve 706 can be configured to provide fluid communication between first longitudinal fluid path 140 and the pig launcher or the pig receiver 710 when in an open position and to isolate the first longitudinal fluid path 140 from the pig launcher or the pig receiver 710 when in a closed position. The fourth valve 709 can be in fluid communication with the second longitudinal fluid path 245 and the pig launcher or pig receiver 710. The fourth valve 709 can be configured to provide fluid communication between the second longitudinal flow path 245 and the pig launcher or the pig receiver 710 when in an open position and to isolate the pig launcher or the pig receiver 710 from the second longitudinal fluid path 245 when in a closed position. In some embodiments, the fluid swivel 500 can be disposed between the bearing 765 of the turret 750 and the pig launcher or the pig receiver 710. In some embodiments, the fluid swivel 500 can be disposed above the bearing 765 of the turret 750 and the pig launcher or the pig receiver 710 can be disposed above the fluid swivel 500.

In some embodiments, a system or apparatus configured to launch or receive the pig 715 can include the turret 750, the fluid swivel 600, and the pig launcher/receiver 710. The turret 750 can include the bearing 765 configured to rotatively couple the fixed part 755 of the turret 750 to the rotating part 760 of the turret 750. The fluid swivel 600 can include the first fixed part 610, the second fixed part 640, the first rotating part 620, and the second rotating part 650. The first fixed part 610 can define the first longitudinal fluid path 612 therethrough, the second longitudinal fluid path 614 therethrough, and the radial fluid path 615 in fluid communication with the first longitudinal fluid path 612. The second fixed part 640 can define the first longitudinal fluid path therethrough 642, the second longitudinal fluid path 644 partially therethrough, and the radial fluid path 646 in fluid communication with the second longitudinal fluid path 644. The first rotating part 620 can define the radial fluid path 622 therethrough. The second rotating part 650 can define the radial fluid path 652 therethrough. The pig launcher or pig receiver 710 can be disposed on the fixed part 755 of the turret 750. The first fixed part 610 of the fluids swivel 600 can be fixedly attached to the second fixed part 640 of the fluid swivel 600. The second fixed part 640 can be fixedly connected to the fixed part 755 of the turret 750. The first rotating part 620 and the second rotating part 650 can be configured to rotate with the rotating part 760 of the turret 750. The first longitudinal fluid path 612 defined by the first fixed part 610 of the fluid swivel 600 and the first longitudinal fluid path 642 defined by the second fixed part 640 of the fluid swivel 600 can be in fluid communication with one another and configured to pass the pig 715 therethrough. The second longitudinal fluid path 614 defined by the first fixed part 610 of the fluid swivel 600 and the second longitudinal fluid path 644 defined by the second fixed part 640 of the fluid swivel 600 can be in fluid communication with one another. The first fixed part 610 of the fluid swivel 600 and the first rotating part 620 of the fluid swivel 600 can define a toroidal fluid path 630 therebetween that can be in fluid communication with the radial fluid path 615 defined by the first fixed part 610 and the radial fluid path 622 defined by the first rotating part 620 of the fluid swivel 600. The second fixed part 640 and the second rotating part 650 can define a toroidal fluid path 662 therebetween that can be in fluid communication with the radial fluid path 646 defined by the second fixed part 640 and the radial fluid path 652 defined by the second rotating part 650 of the fluid swivel 600. In some embodiments, the fluid swivel 600 can further include the structure 660 disposed (i) within the first radial fluid path 615 defined by the first fixed part 610, (ii) within the first longitudinal fluid path 612, or (iii) partially within the first radial fluid path 615 defined by the fixed part 610 and partially within the first longitudinal fluid path 612, where the structure 660 can be configured to prevent the pig 715 from entering the first radial fluid path 615 defined by the fixed part 610 when the pig 715 passes through the first longitudinal fluid path 612. In some embodiments, the first longitudinal fluid path 612 defined by the first fixed part 610 of the fluid swivel 600 can be configured to be in fluid communication with the pig launcher or the pig receiver 710, the second longitudinal fluid path 614 defined by the first fixed part 610 of the fluid swivel 6300 can be configured to be in fluid communication with the pig launcher or the pig receiver 710, and the first longitudinal fluid path 642 defined by the second fixed part 640 can be configured to be in fluid communication with the fluid conduit 705 configured to convey the pig 715 therethrough. In some embodiments, the system or apparatus can also include the first valve 725, the second valve 735, the third valve 706, and the fourth valve 709. The first valve 725 can be in fluid communication with the radial fluid path 622 defined by the first rotating part 520 of the fluid swivel 600. The second valve 735 can be in fluid communication with the radial fluid path 652 defined by the second rotating part 650 of the fluid swivel 600. The third valve 706 can be in fluid communication with the first longitudinal fluid path 612 defined by the first fixed part 610 of the fluid swivel 600 and the pig launcher or the pig receiver 710. The third valve 706 can be configured to provide fluid communication between first longitudinal fluid path 612 and the pig launcher or the pig receiver 710 when in an open position and to isolate the first longitudinal fluid path 612 from the pig launcher or the pig receiver 710 when in a closed position. The fourth valve 709 can be in fluid communication with the second longitudinal fluid path 614 defined by the first fixed part 610 of the fluid swivel 600 and the pig launcher or pig receiver 710. The fourth valve 709 can be configured to provide fluid communication between the second longitudinal flow path 614 and the pig launcher or the pig receiver 710 when in an open position and to isolate the pig launcher or the pig receiver 710 from the second longitudinal fluid path 614 when in a closed position. In some embodiments, the fluid swivel 600 can be disposed between the bearing 765 of the turret 750 and the pig launcher or the pig receiver 710. In some embodiments, the fluid swivel 600 can be disposed above the bearing 765 of the turret 750 and the pig launcher or the pig receiver 710 can be disposed above the fluid swivel 600.

In some embodiments, a system or apparatus configured to launch or receive the pig 715 can include the turret 750, the fluid swivel 600, the pig launcher/receiver 710, the first valve 725, the second valve 735, the third valve 706, and the fourth valve 709. The turret 750 can include the bearing 765 that can be configured to rotatively couple the fixed part 755 of the turret 750 to the rotating part 760 of the turret 750. The fluid swivel 600 can include the first fixed part 610, the second fixed part 640, the first rotating part 620, and the second rotating part 640. The first fixed part 610 can define the first longitudinal fluid path 612 therethrough, the second longitudinal fluid path 614 therethrough, and the first radial fluid path 615 in fluid communication with the first longitudinal fluid path 612. The second fixed part 640 can define the first longitudinal fluid path therethrough 642, the second longitudinal fluid path 644 partially therethrough, and the radial fluid path 646 in fluid communication with the second longitudinal fluid path 644. The first rotating part 620 can define the radial fluid path therethrough 622. The second rotating part 650 can define the radial fluid path 652 therethrough. The pig launcher or a pig receiver 710 can be disposed on the fixed part 755 of the turret 750. The first valve 725 can be in fluid communication with the radial fluid path 622 defined by the first rotating part 620. The second valve 735 can be in fluid communication with the radial fluid path 652 defined by the second rotating part 650. The third valve 706 can be in fluid communication with the first longitudinal fluid path 612 defined by the first fixed part 610 and the pig launcher or the pig receiver 710. The third valve 706 can be configured to isolate the pig launcher or the pig receiver 710 from the first longitudinal fluid path 612 defined by the first fixed part 610. The fourth valve 709 can be in fluid communication with the second longitudinal fluid path 614 defined by the first fixed part 610 and the pig launcher or the pig receiver 710. The fourth valve 709 can be configured to isolate the pig launcher or the pig receiver 710 from the second longitudinal fluid path 914 defined by the first fixed part 610. The first fixed part 610 can be fixedly attached to the second fixed part 640. The second fixed part 640 can be fixedly attached to the fixed part 755 of the turret 750. The first rotating part 620 and the second rotating part 650 can be configured to rotate with the rotating part 760 of the turret 750. The first longitudinal fluid path 612 defined by the first fixed part 610 and the first longitudinal fluid path 642 defined by the second fixed part 640 can be in fluid communication with one another and can be configured to pass the pig 715 therethrough. The second longitudinal fluid path 614 defined by the first fixed part 610 and the second longitudinal fluid path 644 defined by the second fixed part 640 can be in fluid communication with one another. The first fixed part 610 and the first rotating part 620 can define a toroidal fluid path 630 therebetween that can be in fluid communication with the radial fluid path 615 defined by the first fixed part 610 and the radial fluid path 622 defined by the first rotating part 620. The second fixed part 640 and the second rotating part 650 can define a toroidal fluid path 662 therebetween that can be in fluid communication with the radial fluid path 646 defined by the second fixed part 640 and the radial fluid path 652 defined by the second rotating part 650.

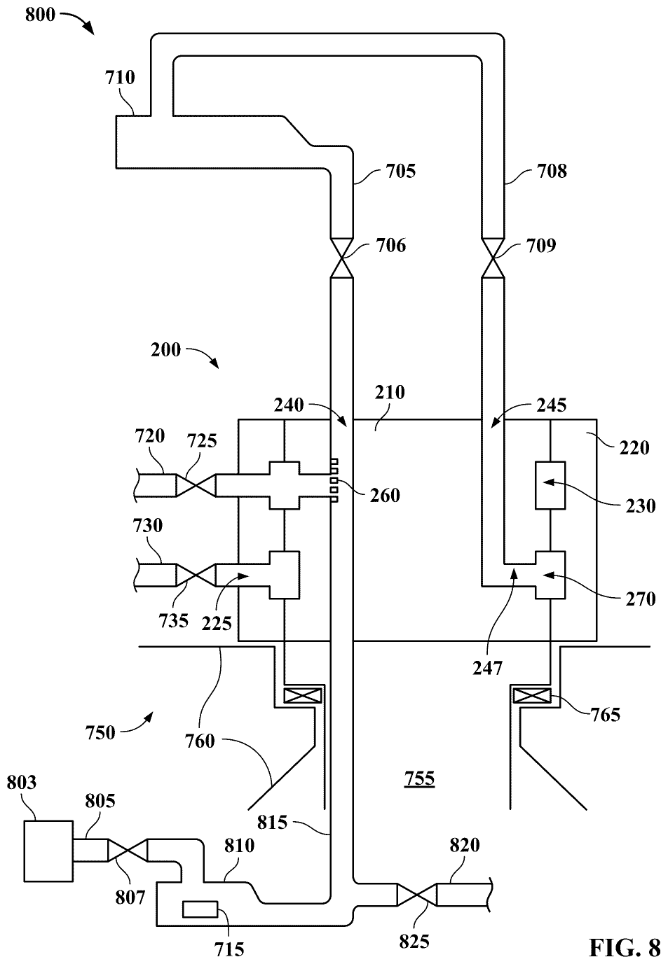

FIG. 8 depicts a cross-section elevational view of the fluid swivel 200 shown in FIG. 3 configured to receive a pig 715 from a pig launcher/receiver 810 through the first longitudinal fluid path 240 defined by the fixed part 210 of the fluid swivel 200 and into the pig launcher/receiver 710, according to one or more embodiments. As shown, the configuration is the same as the configuration shown in FIG. 7, but further includes the pig launcher/receiver 810 disposed below the fluid swivel 200. The pig launcher/receiver 810 can include the pig 715 disposed therein. The pig launcher/receiver 810 can be in fluid communication via conduit 815 with the first longitudinal fluid path 240 defined by the fixed part 210 of the fluid swivel 200. The pig launcher/receiver 810 can also be in fluid communication via conduit 805 with a fluid source 803. The conduit 805 can include a valve or fifth valve 807 that can be configured to fluidly connect the pig launcher/receiver 810 and fluidly isolate the pig launcher/receiver 810 with the first longitudinal fluid path 240 defined by the fixed part 210 of the fluid swivel 200 via actuation of the fifth valve 807.

In some embodiments, a valve (not shown) can be located between the pig launcher/receiver 810 and conduit 815 that can be closed to isolate the pig launcher/receiver 810 from conduit 815. In some embodiments, a switch (not shown) that can be configured to direct the pig 715 from conduit 815 and into the pig launcher/receiver 810 can be located at the junction of conduit 815, conduit 820, and the inlet into the pig launcher/receiver 810. In other embodiments, a structure (not shown) similar to 160, 260, or 560 can be located at the inlet into conduit 820 that can prevent the pig 715 from entering conduit 820.

In some embodiments, a process for launching the pig 715 from the pig launcher/receiver 810, through the fluid swivel 200, and into the pig launcher/receiver 710 can include loading or otherwise inserting the pig 715 into the pig launcher/receiver 810. The first valve 725 can be closed and the second, third, fourth, and fifth valves 735, 706, 709, and 807, respectively, can be opened. Opening the second, third, fourth, and fifth valves 735, 706, 709, and 807 can allow a fluid to flow from the fluid source 803, through the fifth valve 807 and into the pig launcher/receiver 810. The fluid flowing into the pig launcher/receiver 810 can cause the pig 715 to move through conduit 815, through the first longitudinal fluid path 240 defined by the fixed part 210 of the fluid swivel 200, through conduit 705, and into the pig launcher/receiver 710. The fluid can continue to flow from the pig launcher/receiver 710, through conduit 708, through the second longitudinal fluid path 245 and the second radial fluid path 247 defined by the fixed part 210 of the fluid swivel 200, through the second toroidal fluid path 270, through the second radial fluid path 225 defined by the rotating part 220 of the fluid swivel 200, and into conduit 730.

Once the pig 715 has moved from the pig launcher/receiver 810 and into the pig launcher/receiver 710, the second, third, fourth, and fifth valves 735, 706, 709, and 807 can be closed. The first valve 725 can optionally be opened to allow a fluid to flow therethrough either from conduit 720 or into conduit 720. In some embodiments, one or more conduits 820 can also be in fluid communication with the conduit 815. The conduit 815 can include a valve 825 that can be opened/closed when the first valve 725 is opened/closed. As such, when the pig 715 is not being transferred through the fluid conduit 815, either from the pig launcher/receiver 710 to the pig launcher receiver 810 or from the pig launcher/receiver 810 to the pig launcher/receiver 710, one or more fluids can flow from conduit 720 into conduit 820 or from conduit 820 into conduit 720.

As also shown in FIG. 8, the fluid swivel 200 can be disposed on the turret 750. In some embodiments, the fixed part 210 of the fluid swivel 200 can be fixedly connected to the fixed part 755 of the turret 750 and the rotating part 220 of the fluid swivel 200 can be fixedly connected to the rotating part 760 of the turret 750. The turret 750 can include the bearing 765 that can be configured to rotatively couple the fixed part 755 of the turret 750 to the rotating part 760 of the turret 750. As also shown in FIG. 8, the fluid swivel 200 can be disposed on an upper surface of the turret 750 such that the pig launcher/receiver 710 can be located above the turret 750 and above the fluid swivel 200. It should be understood that the fluid swivels 100, 500, and 600 described herein can also be disposed on the turret 750.

In some embodiments, a process for launching a pig 715 through a system can include inserting the pig 715 into the pig launcher 710 disposed on the system. The system can include the turret 750, the fluid swivel 600, the first valve 725, the second valve 735, the third valve 706, and the fourth valve 709. The turret 750 can include the bearing 765 configured to rotatively couple the fixed part 755 of the turret 750 to the rotating part 760 of the turret 750. The fluid swivel 600 can include the first fixed part 610, the second fixed part 640, the first rotating part 620, and the second rotating part 640. The first fixed part 610 can define the first longitudinal fluid path 612 therethrough, the second longitudinal fluid path 614 therethrough, and the first radial fluid 615 path in fluid communication with the first longitudinal fluid path 612. The second fixed part 640 can define the first longitudinal fluid path 642 therethrough, the second longitudinal fluid path 644 partially therethrough, and the radial fluid path 646 in fluid communication with the second longitudinal fluid path 644. The first rotating part 620 can define the radial fluid path 622 therethrough. The second rotating part 650 can define the radial fluid path 652 therethrough. The first valve 725 can be in fluid communication with the radial fluid path 622 defined by the first rotating part 620. The second valve 735 can be in fluid communication with the radial fluid path 652 defined by the second rotating part 650. The third valve 706 can be in fluid communication with the first longitudinal fluid path 612 defined by the first fixed part 610 and the pig launcher 710. The third valve 706 can be configured to provide fluid communication between first longitudinal fluid path 612 and the pig launcher 710 when in an open position and to isolate the first longitudinal fluid path 612 from the pig launcher 710 when in a closed position. The fourth valve 709 can be in fluid communication with the second longitudinal fluid path 614 defined by the first fixed part 610 and the pig launcher 710. The fourth valve 709 can be configured to provide fluid communication between the second longitudinal fluid path 614 and the pig launcher 710 when in an open position and to isolate the second longitudinal fluid path 614 from the pig launcher 710 when in a closed position. The second fixed part 640 of the fluid swivel 600 can be fixedly attached to the fixed part 755 of the turret 750. The first fixed part 610 of the fluid swivel 600 can be fixedly attached to the second fixed part 640 of the fluid swivel 600. The first rotating part 620 and the second rotating part 650 can be configured to rotate with the rotating part 760 of the turret 750. The first longitudinal fluid path 612 defined by the first fixed part 610 and the first longitudinal fluid path 642 defined by the second fixed part 640 can be in fluid communication with one another and configured to pass the pig 715 therethrough. The second longitudinal fluid path 614 defined by the first fixed part 610 and the second longitudinal fluid path 644 defined by the second fixed part 640 can be in fluid communication with one another. The first fixed part 610 and the first rotating part 620 can define the toroidal fluid path 630 therebetween that can be in fluid communication with the radial fluid path 615 defined by the first fixed part 610 and the radial fluid path 622 defined by the first rotating part 620. The second fixed part 640 and the second rotating part 650 can define the toroidal fluid path 662 therebetween that can be in fluid communication with the radial fluid path 646 defined by the second fixed part 640 and the radial fluid path 652 defined by the second rotating part 650. The process can also include closing the first valve 725, opening the second valve 735, opening the third valve 706, and opening the fourth valve 709, where opening the second, third, and fourth valves 735, 706, 709, respectively, causes a fluid to flow through the radial fluid path 652 defined by the second rotating part 650, into the toroidal fluid path 662 defined between the second fixed part 640 and the second rotating part 650, through the radial fluid path 646 defined by the second fixed part 640, through the second longitudinal fluid path 644 defined by the second fixed part 640, through the second longitudinal fluid path 614 defined by the first fixed part 610, and into the pig launcher 710. The fluid flowing into the pig launcher 710 can cause the pig 715 to move into and through the first longitudinal fluid path 612 defined by the first fixed part 610 and into and through the first longitudinal fluid path 642 defined by the second fixed part 640.

In some embodiments, a process for receiving a pig from a system can include receiving the pig 715 into the pig receiver 710 disposed on the system. The system can include the turret 750, the fluid swivel 600, the first valve 725, the second valve 735, the third valve 706, the fourth valve 709, the fifth valve 807, and the pig launcher 810. The turret 750 can include the bearing 765 configured to rotatively couple the fixed part 755 of the turret 750 to the rotating part 760 of the turret 750. The fluid swivel 600 can include the first fixed part 610, the second fixed part 640, the first rotating part 620, and the second rotating part 640. The first fixed part 610 can define the first longitudinal fluid path 612 therethrough, the second longitudinal fluid path 614 therethrough, and the first radial fluid 615 path in fluid communication with the first longitudinal fluid path 612. The second fixed part 640 can define the first longitudinal fluid path 642 therethrough, the second longitudinal fluid path 644 partially therethrough, and the radial fluid path 646 in fluid communication with the second longitudinal fluid path 644. The first rotating part 620 can define the radial fluid path 622 therethrough. The second rotating part 650 can define the radial fluid path 652 therethrough. The first valve 725 can be in fluid communication with the radial fluid path 622 defined by the first rotating part 620. The second valve 735 can be in fluid communication with the radial fluid path 652 defined by the second rotating part 650. The third valve 706 can be in fluid communication with the first longitudinal fluid path 612 defined by the first fixed part 610 and the pig receiver 710. The third valve 706 can be configured to provide fluid communication between first longitudinal fluid path 612 and the pig receiver 710 when in an open position and to isolate the first longitudinal fluid path 612 from the pig receiver 710 when in a closed position. The fourth valve 709 can be in fluid communication with the second longitudinal fluid path 614 defined by the first fixed part 610 and the pig receiver 710. The fourth valve 709 can be configured to provide fluid communication between the second longitudinal fluid path 614 and the pig receiver 710 when in an open position and to isolate the second longitudinal fluid path 614 from the pig receiver 710 when in a closed position. The fifth valve 807 can be in fluid communication with the pig launcher 810 and the fluid source 803. The fifth valve can be configured to provide fluid communication between the fluid source 803 and the pig launcher 810 when in the open position and to isolate the pig launcher 810 from the fluid source 801 when in the closed position. The second fixed part 640 of the fluid swivel 600 can be fixedly attached to the fixed part 755 of the turret 750. The first fixed part 610 of the fluid swivel 600 can be fixedly attached to the second fixed part 640 of the fluid swivel 600. The first rotating part 620 and the second rotating part 650 can be configured to rotate with the rotating part 760 of the turret 750. The first longitudinal fluid path 612 defined by the first fixed part 610 and the first longitudinal fluid path 642 defined by the second fixed part 640 can be in fluid communication with one another and configured to pass the pig 715 therethrough. The second longitudinal fluid path 614 defined by the first fixed part 610 and the second longitudinal fluid path 644 defined by the second fixed part 640 can be in fluid communication with one another. The first fixed part 610 and the first rotating part 620 can define the toroidal fluid path 630 therebetween that can be in fluid communication with the radial fluid path 615 defined by the first fixed part 610 and the radial fluid path 622 defined by the first rotating part 620. The second fixed part 640 and the second rotating part 650 can define the toroidal fluid path 662 therebetween that can be in fluid communication with the radial fluid path 646 defined by the second fixed part 640 and the radial fluid path 652 defined by the second rotating part 650. The process can also include closing the first valve 735, opening the second valve 735, opening the third valve 706, opening the fourth valve 709, and opening the fifth valve 807. Closing the first valve 725 and opening the second, third, fourth, and fifth valves 735, 706, 709, and 807 can allow the fluid to flow from the fluid source 803, through the fifth valve 807 and into the pig launcher/receiver 810. The fluid flowing into the pig launcher/receiver 810 can cause the pig 715 to move through conduit 815, through the first longitudinal fluid path 642 defined by the second fixed part 640 of the fluid swivel 600, through the first longitudinal fluid path 612 defined by the first fixed part 610 of the fluid swivel, through conduit 705, and into the pig receiver 710. The fluid can continue to flow from the pig receiver 710, through conduit 708, through the second longitudinal fluid path 614 defined by the first fixed part 610, through the second longitudinal fluid path 644 defined by the second fixed part 650, through the radial fluid path 646 defined by the second fixed part 640, into the toroidal fluid path 662, and through the radial fluid path 652 defined by the second rotating part 650 of the fluid swivel 600, and into conduit 730.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim can be not defined above, it should be given the broadest definition persons in the pertinent art have given that term as reflected in at least one printed publication or issued patent. Furthermore, all patents, test procedures, and other documents cited in this application are fully incorporated by reference to the extent such disclosure can be not inconsistent with this application and for all jurisdictions in which such incorporation can be permitted.

While certain preferred embodiments of the present invention have been illustrated and described in detail above, it can be apparent that modifications and adaptations thereof will occur to those having ordinary skill in the art. It should be, therefore, expressly understood that such modifications and adaptations may be devised without departing from the basic scope thereof, and the scope thereof can be determined by the claims that follow.

What is claimed is:

1. An apparatus, comprising:
a fluid swivel comprising a fixed part that defines a first longitudinal fluid path therethrough and a first radial fluid path in fluid communication with the first longitudinal fluid path; and
a rotating part that defines a first radial fluid path therethrough; wherein:
the first longitudinal fluid path is configured to pass a pig therethrough, and
the first fixed part and the first rotating part define a first toroidal fluid path therebetween that is in fluid communication with the first radial fluid path defined by the fixed part and the first radial fluid path defined by the rotating part.

2. The apparatus of claim 1, further comprising a structure disposed (i) within the first radial fluid path defined by the fixed part, (ii) within the first longitudinal fluid path, or (iii) partially within the first radial fluid path defined by the fixed part and partially within the first longitudinal fluid path, wherein the structure is configured to prevent the pig from entering the first radial fluid path defined by the fixed part when the pig passes through the first longitudinal fluid path.

3. The apparatus of claim 1, further comprising a turret comprising a bearing configured to rotatively couple a fixed part of the turret to a rotating part of the turret, wherein:
the fixed part of the fluid swivel is fixedly connected to the fixed part of the turret, and
the rotating part of the fluid swivel is fixedly connected to the rotating part of the turret.

4. The apparatus of claim 1, further comprising:
a turret comprising a bearing configured to rotatively couple a fixed part of the turret to a rotating part of the turret;
a pig launcher or a pig receiver disposed on the fixed part of the turret; and
a valve in fluid communication with the first longitudinal fluid path and the pig launcher or the pig receiver, wherein:
the fixed part of the fluid swivel is fixedly connected to the fixed part of the turret,
the rotating part of the fluid swivel is configured to rotate with the rotating part of the turret, and
the valve is configured to provide fluid communication between first longitudinal fluid path and the pig launcher or the pig receiver when in an open position and to isolate the first longitudinal fluid path from the pig launcher or the pig receiver when in a closed position.

5. The apparatus of claim 1, wherein:
the fixed part defines a second longitudinal fluid path partially therethrough and a second radial fluid path in fluid communication with the second longitudinal fluid path,
the rotating part defines a second radial fluid path therethrough, and
the fixed part and the rotating part define a second toroidal fluid path therebetween that is in fluid communication with the second radial fluid path defined by the fixed part and the second radial fluid path defined by the rotating part.

6. The apparatus of claim 5, further comprising a structure disposed (i) within the first radial fluid path defined by the fixed part, (ii) within the first longitudinal fluid path, or (iii) partially within the first radial fluid path defined by the fixed part and partially within the first longitudinal fluid path, wherein the structure is configured to prevent the pig from entering the first radial fluid path defined by the fixed part when the pig passes through the first longitudinal fluid path.

7. The apparatus of claim 5, further comprising a turret comprising a bearing configured to rotatively couple a fixed part of the turret to a rotating part of the turret, wherein:
the fixed part of the fluid swivel is fixedly connected to the fixed part of the turret, and
the rotating part of the fluid swivel is configured to rotate with the rotating part of the turret.

8. The apparatus of claim 7, further comprising:
a pig launcher or a pig receiver disposed on the fixed part of the turret;
a first valve in fluid communication with the first radial fluid path defined by the rotating part of the fluid swivel;
a second valve in fluid communication with the second radial fluid path defined by the rotating part of the fluid swivel;
a third valve in fluid communication with the first longitudinal fluid path and the pig launcher or the pig receiver, wherein the third valve is configured to provide fluid communication between first longitudinal fluid path and the pig launcher or the pig receiver when in an open position and to isolate the first longitudinal fluid path from the pig launcher or the pig receiver when in a closed position; and
a fourth valve in fluid communication with the second longitudinal fluid path and the pig launcher or pig receiver, wherein the fourth valve is configured to provide fluid communication between the second longitudinal fluid path and the pig launcher or the pig receiver when in an open position and to isolate the second longitudinal fluid path from the pig launcher or the pig receiver when in a closed position.

9. The apparatus of claim 8, further comprising a structure disposed (i) within the first radial fluid path defined by the fixed part, (ii) within the first longitudinal fluid path, or (iii) partially within the first radial fluid path defined by the fixed part and partially within the first longitudinal fluid path, wherein the structure is configured to prevent the pig from entering the first radial fluid path defined by the fixed part when the pig passes through the first longitudinal fluid path.

10. An apparatus, comprising:
a fluid swivel comprising a fixed part that defines a first longitudinal fluid path therethrough, a second longitudinal fluid path partially therethrough, a first radial fluid path in fluid communication with the first longitudinal fluid path, and a second radial fluid path in fluid communication with the second longitudinal fluid path;
a first rotating part that defines a radial fluid path therethrough; and
a second rotating part that defines a radial fluid path therethrough; wherein:
the first longitudinal fluid path is configured to pass a pig therethrough,
the fixed part and the first rotating part define a toroidal fluid path therebetween that is in fluid communication with the first radial fluid path defined by the fixed part and the radial fluid path defined by the first rotating part, and
the fixed part and the second rotating part define a toroidal fluid path therebetween that is in fluid communication with the second radial fluid path defined by the fixed part and the radial fluid path defined by the second rotating part.

11. The apparatus of claim 10, further comprising a structure disposed (i) within the first radial fluid path defined by the fixed part, (ii) within the first longitudinal fluid path, or (iii) partially within the first radial fluid path defined by the fixed part and partially within the first longitudinal fluid path, wherein the structure is configured to prevent the pig from entering the first radial fluid path defined by the fixed part when the pig passes through the first longitudinal fluid path.

12. The apparatus of claim 10, further comprising a turret comprising a bearing configured to rotatively couple a fixed part of the turret to a rotating part of the turret, wherein:
the fixed part of the fluid swivel is fixedly connected to the fixed part of the turret, and
the rotating part of the fluid swivel is configured to rotate with the rotating part of the turret.

13. The apparatus of claim 12, further comprising:
a pig launcher or a pig receiver disposed on the fixed part of the turret;
a first valve in fluid communication with the radial fluid path defined by the first rotating part of the fluid swivel;
a second valve in fluid communication with the radial fluid path defined by the second rotating part of the fluid swivel;
a third valve in fluid communication with the first longitudinal fluid path and the pig launcher or the pig receiver, wherein the third valve is configured to provide fluid communication between the first longitudinal fluid path and the pig launcher or the pig receiver when in an open position and to isolate the first longitudinal fluid path from the pig launcher or the pig receiver when in a closed position; and
a fourth valve in fluid communication with the second longitudinal fluid path and the pig launcher or pig receiver, wherein the fourth valve is configured to provide fluid communication between the second longitudinal fluid path and the pig launcher or the pig receiver when in an open position and to isolate the second longitudinal fluid path from the pig launcher or the pig receiver when in a closed position.

14. The apparatus of claim 13, further comprising a structure disposed (i) within the first radial fluid path defined by the fixed part, (ii) within the first longitudinal fluid path, or (iii) partially within the first radial fluid path defined by the fixed part and partially within the first longitudinal fluid path, wherein the structure is configured to prevent the pig from entering the first radial fluid path defined by the fixed part when the pig passes through the first longitudinal fluid path.

15. An apparatus, comprising:
a fluid swivel comprising:
a first fixed part that defines a first longitudinal fluid path and a second longitudinal fluid path therethrough and a radial fluid path in fluid communication with the first longitudinal fluid path defined by the first fixed part;
a second fixed part that defines a first longitudinal fluid path therethrough, a second longitudinal fluid path partially therethrough, and a radial fluid path in fluid communication with the second longitudinal fluid path defined by the second fixed part;
a first rotating part that defines a radial fluid path therethrough; and
a second rotating part that defines a radial fluid path therethrough; wherein:
the first fixed part and the second fixed part are fixedly connected to one another,
the first longitudinal fluid path defined by first fixed part and the first longitudinal fluid path defined by the second fixed part are configured to pass a pig therethrough,
the first fixed part and the first rotating part define a toroidal fluid path therebetween that is in fluid communication with the radial fluid path defined by the first fixed part and the radial fluid path defined by the first rotating part, and
the second fixed part and the second rotating part define a toroidal fluid path therebetween that is in fluid communication with the radial fluid path defined by the second fixed part and the radial fluid path defined by the second rotating part.

16. The apparatus of claim 15, further comprising a structure disposed (i) within the radial fluid path defined by the first fixed part, (ii) within the first longitudinal fluid path defined by the first fixed part, or (iii) partially within the radial fluid path defined by the first fixed part and partially within the first longitudinal fluid path defined by the first fixed part, wherein the structure is configured to prevent the pig from entering the first radial fluid path defined by the fixed part when the pig passes through the first longitudinal fluid path.

17. The apparatus of claim 15, further comprising a turret comprising a bearing configured to rotatively couple a fixed part of the turret to a rotating part of the turret, wherein:
the second fixed part of the fluid swivel is fixedly connected to the fixed part of the turret, and
the first rotating part and the second rotating part of the fluid swivel are configured to rotate with the rotating part of the turret.

18. The apparatus of claim 17, further comprising:
a pig launcher or a pig receiver disposed on the fixed part of the turret;
a first valve in fluid communication with the radial fluid path defined by the first rotating part of the fluid swivel;
a second valve in fluid communication with the radial fluid path defined by the second rotating part of the fluid swivel;
a third valve in fluid communication with the first longitudinal fluid path defined by the first fixed part and the pig launcher or the pig receiver, wherein the third valve is configured to provide fluid communication between the first longitudinal fluid path defined by the first fixed part and the pig launcher or the pig receiver when in an open position and to isolate the first longitudinal fluid path defined by the first fixed part from the pig launcher or the pig receiver when in a closed position; and
a fourth valve in fluid communication with the second longitudinal fluid path defined by the first fixed part and the pig launcher or pig receiver, wherein the fourth valve is configured to provide fluid communication between the second longitudinal fluid path define by the first fixed part and the pig launcher or the pig receiver when in an open position and to isolate the second longitudinal fluid path defined by the first fixed part from the pig launcher or the pig receiver when in a closed position.

19. The apparatus of claim 18, further comprising a structure disposed (i) within the radial fluid path defined by the first fixed part, (ii) within the first longitudinal fluid path defined by the first fixed part, or (iii) partially within the radial fluid path defined by the first fixed part and partially within the first longitudinal fluid path defined by the first fixed part, wherein the structure is configured to prevent the pig from entering the first radial fluid path defined by the fixed part when the pig passes through the first longitudinal fluid path.

20. The apparatus of claim 19, wherein the structure comprises or more bars, one or more plates, a gate, a grate, a screen, or a combination thereof.
